(19) United States
(12) Patent Application Publication
(10) Pub. No.: US 2005/0083411 A1
(43) Pub. Date: Apr. 21, 2005

(54) Device driven share system and method

(76) Inventors: Robert P. Cozier, Fort Collins, CO (US); Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/686,854

(22) Filed: Oct. 16, 2003

(51) Int. Cl. H04N 5/232; H04N 5/225; H04N 5/228

(52) U.S. Cl. 348/211.1; 348/211.2; 348/211.3; 348/207.1; 348/208.12

(57) ABSTRACT

A system and method comprising a user device having a customizable share system that is external device driven, and which is configured by way of communication between the user device and the external device. The customizable share system allows a user to be aware of the capabilities of an external device that is connected to the user device. This is implemented using a user interface on the user's device, such as a camera or device display, for example.

### TECHNICAL FIELD

The present invention relates generally to display systems and methods, such as those involving digital cameras, and the like.

### BACKGROUND

Manufacturers have heretofore developed a sharing system that is employed in digital cameras. This sharing system for the digital camera allows pictures to be transferred to external devices, specifically to allow printing of pictures and transfer of pictures to specific friends and family, for example.

Heretofore, using this previously developed sharing system, a user had no knowledge of the capabilities of the external device or the actions that the external device could perform. The problem is that the user might mistakenly think that a photograph could be e-mailed to another device, but in fact, the camera is connected to a non-web enabled printer. The user's intent to e-mail the photograph would not be executed, and only a print would be made.

### SUMMARY OF THE INVENTION

The present invention provides for a system and method comprising a user device having a customizable share system that is external device driven. The share system is configured by way of communication between the user device and the external device. The customizable share system allows a user to be aware of the capabilities of an external device that is connected to the user device. This is implemented using a user interface on the user's device, such as a camera/device display, for example.

An exemplary system for communicating with an external device comprises a display and a customizable share menu that is displayable on the display. The share menu comprises a plurality of selectable icons that respectively correspond to selected tasks or actions that may be performed by a user, and which initiate a through connection with the external device, and, when selected, cause the selected task or action to be performed on the external device in a preprogrammed manner.

The external device communicates identifying information to the system that identifies the external device and its capabilities, and in response, the system configures the share menu according to the capabilities of the external device. In response to selecting one of the one or more selectable icons to perform a desired task, the system checks whether the selection that has been made matches the capabilities of the connected external device, and if the selection matches the external device capabilities, performs the desired task by communicating between the user device and the external device.

An exemplary method comprises the following steps. A user device, such as a camera, is configured to have a share menu that is displayable on a display of the user device and which comprises one or more selectable icons that correspond to selected tasks or actions that may be performed by a user.

The user device connects to one or more external devices. The external devices communicate identifying information to the user device using a predetermined connection protocol or file system, to identify the external devices and their capabilities. The user device identifies which external devices are connected to it, and configures the share menu according to the capabilities of the external device.

A user selects one of the one or more selectable icons to perform a desired task on one of the external devices. The user device checks whether the selection that has been made that matches the capabilities of the external device. If the selection matches the external device capabilities, the desired task is performed by communicating between the user device and the external device.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are front and back views, respectively, that illustrate an exemplary embodiment of a digital camera embodying a share system, display system and display method in accordance with the principles of the present invention;

FIG. 2 illustrates an exemplary embodiment of the share system, display system and display method in accordance with the principles of the present invention; and

FIG. 3 illustrates an exemplary method in accordance with the principles of the present invention.

### DETAILED DESCRIPTION

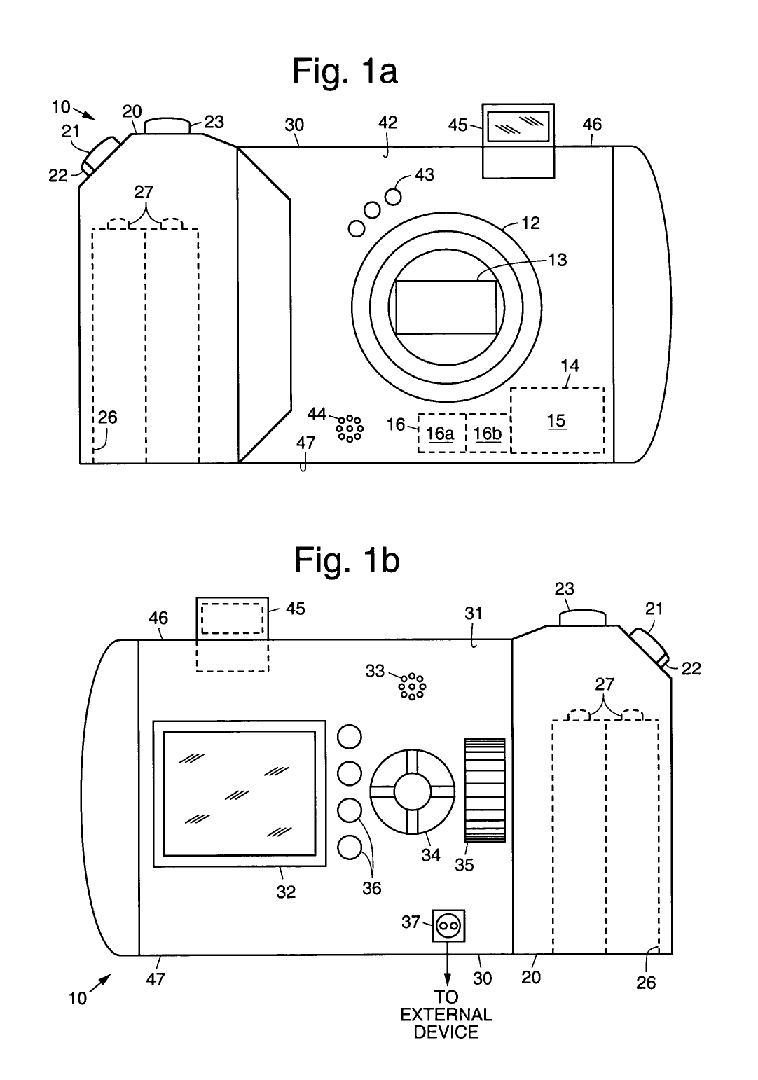

Referring to the drawing figures, FIGS. 1a and 1b show front and back views, respectively, that illustrate an exemplary embodiment of a digital still camera 10 that embodies a customizable share system 40, display system 50 and display method 70 in accordance with the principles of the present invention.

The exemplary digital camera 10 comprises a handgrip section 20 and a body section 30. The handgrip section 20 includes a power button 21 having a lock latch 22, a shutter button 23 (or record button 23), and a battery compartment 26 for housing batteries 27. A metering element 43 and microphone 44 are disposed on a front surface 42 of the digital camera 10. A pop-up flash 45 is located adjacent the top surface 46 of the digital camera 10.

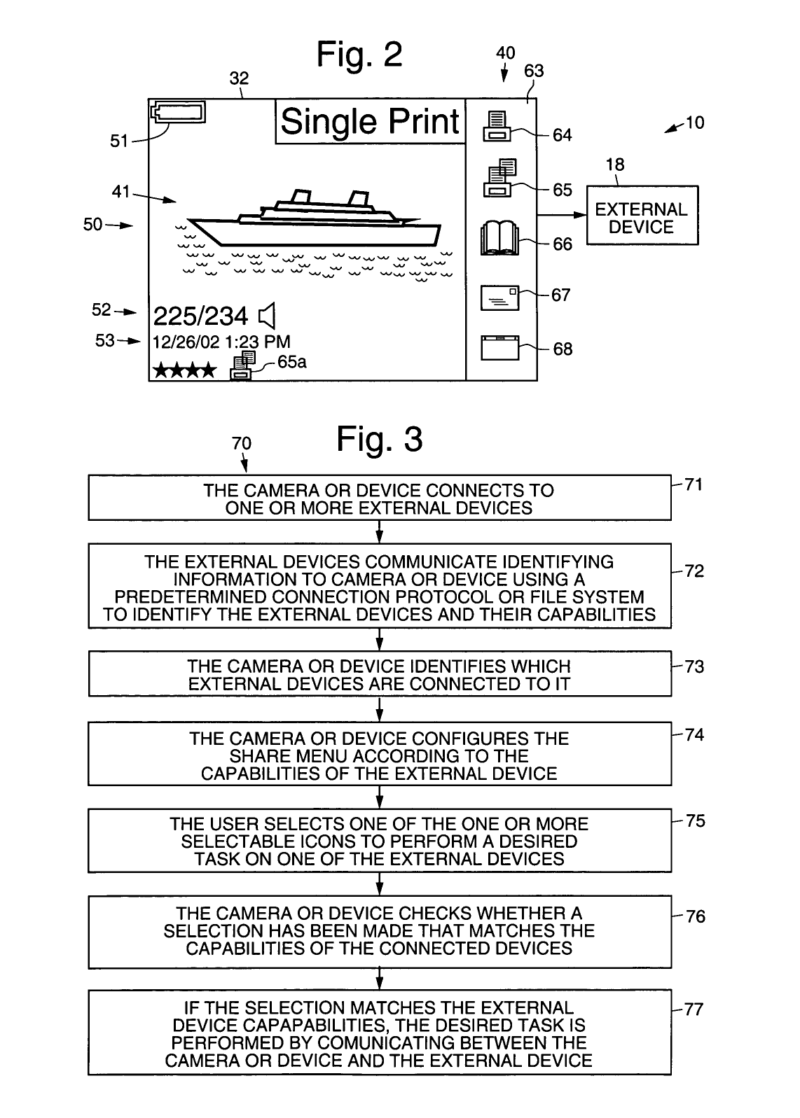

As is shown in FIG. 1b, a rear surface 31 of the exemplary digital camera 10 includes a display 32, such as a liquid crystal display (LCD) 32, for example, a rear microphone 33, a joystick pad 34, a zoom control dial 35, a plurality of buttons 36 for setting functions of the camera 10 and an output port 37 for downloading images 41 (FIG. 2) to an external device 18 (FIG. 2), such as a printer, computer, or wireless telephone, for example, or to another device 18 by way of the Internet, for example.

The digital camera 10 also comprises a lens 12, or imaging optics 12, and an image sensor 13 for receiving images 41 transmitted by the imaging optics 12. A processor 14 is coupled to the image sensor 13 (and other control and input/output components). The processor 14 is also coupled to image memory 16, which may include internal memory 16 and removable memory 16. The processor 14 comprises a algorithm 15 that implements the present customizable share system 40, display system 50 and display method 70.

FIG. 2 illustrates an exemplary embodiment of the customizable share system 40, display system 50 and display method 70 in accordance with the principles of the present invention. The exemplary customizable share system 40 shown in FIG. 2 comprises a customizable share menu 63 that is displayed on the display 32, such as the liquid crystal display (LCD) 32, for example.

The display 32 of the camera 10 is caused to display the selected picture 41 on which an action or actions are to be taken. The display 32 illustrates a battery 51 that indicates the amount of battery charge that is left. The display 32 shows the number 52 of the picture 51 (225/234) that is displayed. The display 32 also shows the current date (Dec. 26, 2002) and time (1:23. PM) 53. In addition, the specific action that is being performed, illustrates as icon 65a, is also shown along with its progress, illustrated by a progression of stars, for example.

The share menu 63 includes a plurality of customizable and selectable icons 64, 65, 66, 67, 68. Each of the icons 64-68 correspond to a selected task or action that may be performed with regard to a picture 41 or photographic image 41 (photograph 41) that is taken by a user.

The icons 64, 65, 66, 67, 68 of the share menu 63 which appear on the on the right side of display 32 of the digital still camera 10 in this example, perform multiple operations relating to the external device 18 such as e-mail, print, and send to web, for example. For example, a first icon 64 illustrates a printer icon 64 that is selected to print a single picture 41. A second icon 65 illustrates a printer icon 65 that is selected to print multiple or all pictures 41. A third icon 66 illustrates a book icon 66 that is selected to archive one or more pictures 41. A fourth icon 67 illustrates an envelope icon 67 that is selected to e-mail a picture 41. A fifth icon 68 illustrates a computer desktop icon 68 that is selected to download a picture 41 to a designated computer, for example.

The camera 10 may, however, perform more operations than just these. For example, a camera 10 may connect directly to a printer and only execute print selections. Alternatively the camera 10 may connect to a printer and only want to show certain actions to the user.

By way of example, the first two icons 64, 65 as they relate to the present invention will be discussed. The first icon 64 causes the camera 10 to print a single 4×6 print, and the second icon 65 causes the camera 10 to print multiple 4×6 prints. When the camera 10 is connected either directly to a printer or directly to a computer, the entire menu 63 would be displayed on the display 32 of the camera 10. If either of the first two icons 64, 65 are selected for execution the respective printouts are executed.

Let's say that no share menu selections have been made. In the share system of the prior art, the system would look the same after the user has been prompted to bring up the share menu 63 and select what action should be taken regarding the underlying photograph 41 (or data). The problem is that the user might mistakenly think that he or she can chose to e-mail the photograph 41, but in fact, the camera 10 is connected to a currently non-web enabled printer. The user's intent to e-mail the photograph 41 would not be executed, and instead only the prints would be made.

In order to simplify the user experience, and in accordance with the present invention, a device identification (ID) is provided for each external device 18 to which the camera 10 is connected that has an impact on what the share menu 63 looks like. If the camera 10 is connected to a printer 18 at the time of selection of a print icon 64, 65, for example, only the print icons 64, 65 would be shown on the share menu 63 with their associated text, thus eliminating any confusion over the intended or available share destination. An optional text string input by the user may also be displayed to describe the action (“Single Print” shown in FIG. 2 is an example).

The printer 18 is a readily available device type that has a device driver that can communicate the device identification (ID) for use by the share system 50 and share menu 63. However, other external devices 18 such as computers, kiosks having specific device drivers, handheld computers, and PDA cell phone combinations may be configured to have a device driver that can communicate their capabilities by way of specific device IDs to the camera 10 and share system 40.

The external device 18 communicates with the camera 10 using a either predetermined connection protocol, such as the universal serial bus (USB) protocol, for example, or using a file system. The camera 10 configures the icons 64-68 of the share menu 63 to correspond to the capabilities of the connected external device 18. For example, certain icons 64-68 may be grayed out or removed from the share menu 63 is their intended actions cannot be performed by the external device 18. This allows the user to readily determine the capabilities of the external device 18 to simplify execution of intended tasks or actions that are to be taken (i.e., print, e-mail, etc).

This provides for clearer definition of what the external device 18 can execute and whether it can execute any of the capabilities that the user intends. For example, the display screen 32 on the camera 10 or device 10 might say “No intents selected for current external device”, and list the possibilities that the user can chose from to do something (carriage return/tap screen etc.) when done.

With the above in mind, FIG. 3 illustrates an exemplary method 70 in accordance with the principles of the present invention. The exemplary method 70 comprises the following steps.

A user device 10 (such as a camera 10) is configured 71 to have a share menu 43 that is displayable on a display of the user device and which comprises one or more selectable icons 44-48 that correspond to selected tasks or actions that may be performed by a user.

The camera 10 or device 10 connects 72 to one or more external devices 18. The external devices 18 communicate 73 identifying information to the camera 10 or device 10 using a predetermined connection protocol or file system, to identify what the external devices 18 are and what the capabilities of the external devices 18 are (i.e., the tasks that the external devices 18 can perform).

The camera 10 or device 10 identifies which external devices 18 are connected to it, and configures 74 the share menu according to the capabilities of the external device 18. For example, the camera 10 or device 10 selects appropriate capabilities of the external devices 18 for the share menu 43, such as by graying out icons associated with missing capabilities, for example, such as by graying out the e-mail icon 44 in the print situation discussed above, or not showing the e-mail icon 44 or other non-enabled icons 47, 48.

The user selects 75 one of the one or more selectable icons to perform a desired task on one of the external devices 18. The camera 10 or device 10 checks 76 whether the selection that has been made that matches the capabilities of the external device 18. If the selection matches the external device capabilities, the desired task is performed 77 by communicating between the camera 10 or device 10 and the external device 18.

The present invention to provides for simplified human interaction with both the user device 10 and the external device 18. The present invention to provides for a system in which the user can easily see (using camera/device capabilities such as the LCD 32) the capabilities of the external device 18.

The present invention eliminates scrolling over items that cannot be executed by the external device 18. This reduces scrolling and maximizes the number of items that are displayed on the display screen 32.

Thus, an improved share system that is device driven and related method have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A system for communicating with an external device, comprising:
a display; and
a customizable share menu that is displayable on the display and which comprises a plurality of selectable icons that respectively correspond to selected tasks or actions that may be performed by a user, and which initiate a through connection with the external device, and, when selected, cause the selected task or action to be performed on the external device in a preprogrammed manner;
wherein the external device communicates identifying information to the system that identifies the external device and its capabilities, and in response, the system configures the share menu according to the capabilities of the external device;
and wherein, in response to selecting one of the one or more selectable icons to perform a desired task, the system checks whether the selection that has been made matches the capabilities of the connected external device, and if the selection matches the external device capabilities, performs the desired task by communicating between the user device and the external device.

2. The system recited in claim 1 which comprises a digital camera.

3. The system recited in claim 1 wherein the tasks are selected from a group consisting of printing, e-mailing, archiving and downloading data from the system.

4. The system recited in claim 1 wherein the external device comprises a printer.

5. The system recited in claim 1 wherein the external device comprises a computer.

6. The system recited in claim 1 wherein the external device comprises a wireless telephone.

7. A method comprising the steps of;
configuring a user device to have a share menu that is displayable on a display of the user device and which comprises one or more selectable icons that correspond to selected tasks or actions that may be performed by a user;
connecting the user device to an external device;
communicating identifying information from the external device to the user device that identifies the external device and its capabilities;
configuring the share menu according to the capabilities of the external device selecting one of the one or more selectable icons to perform a desired task;
checking whether the selection that has been made matches the capabilities of the connected external device; and
if the selection matches the external device capabilities, performing the desired task by communicating between the user device and the external device.

8. The method recited in claim 7 wherein the step of communicating uses a predetermined connection protocol.

9. The method recited in claim 7 wherein the step of communicating uses a file system.

10. The method recited in claim 7 wherein the device comprises a digital camera.

11. The method recited in claim 7 wherein the tasks are selected from a group consisting of printing, e-mailing, archiving and downloading data from the system.

12. The method recited in claim 7 wherein the external device comprises a printer.

13. The method recited in claim 7 wherein the external device comprises a computer.

14. The method recited in claim 7 wherein the external device comprises a wireless telephone.

15. A system for communicating with an external device, comprising:
a display; and
customizable displayable sharing means that is presentable on the display and which comprises a plurality of selectable icons that respectively correspond to selected tasks or actions that may be performed by a user, for initiating a through connection with the external device, and for causing a selected task or action to be performed on the external device in a preprogrammed manner.

16. The system recited in claim 15 wherein the external device communicates identifying information to the system that identifies the external device and its capabilities, and in response, the system configures the share menu according to the capabilities of the external device.

17. The system recited in claim 15 wherein, in response to selecting one of the one or more selectable icons to perform a desired task, the system checks whether the selection that has been made matches the capabilities of the connected external device, and if the selection matches the external device capabilities, performs the desired task by communicating between the user device and the external device.
